(19) United States
(12) Patent Application Publication
(10) Pub. No.: US 2009/0091169 A1
(43) Pub. Date: Apr. 9, 2009

(54) Lumbar support for a motor vehicle seat

(76) Inventors: Guido Neumann, Ilmenau (DE); Oliver Steffen, Coburg (DE)

Correspondence Address: CHRISTIE, PARKER & HALE, LLP, PO BOX 7068, PASADENA, CA, 91109-7068, US

(21) Appl. No.: 11/920,361

(22) PCT Filed: May 5, 2006
(86) PCT No.: PCT/DE2006/000818

§ 371 Date: Dec. 18, 2007

(30) Foreign Application Priority Data
May 12, 2005 (DE) 20 2005 007 802.6
Aug. 10, 2005 (DE) 10 2005 037 682.7
Dec. 9, 2005 (DE) 10 2005 058 904.9

(51) Int. Cl. B60N 2/66

(52) U.S. Cl. 297/284.4

(57) ABSTRACT

A lumbar adjuster for a motor vehicle seat includes a frame which supports the lumbar adjuster and two pivotal bows which intersect in the manner of a pair of scissors, wherein at least one bow is assigned a linearly movable slide for pivoting it. The slide is arranged in the scissor area of the bows.

### CROSS-REFERENCE TO A RELATED APPLICATION

This application is a National Phase Patent Application of International Patent Application Number PCT/DE2006/000818, filed on May 5, 2006, which claims priority of German Utility Model Application Number 20 2005 007 802.6, filed on May 12, 2005, German Patent Application Number 10 2005 037 682.7, filed on Aug. 10, 2005 and German Patent Application Number 10 2005 058 904.9, filed on Dec. 9, 2005.

### BACKGROUND

The invention relates to a lumbar adjuster for a motor vehicle seat.

A known backrest structure comprises a backrest frame which has a front side which faces the seat user's back and along which the seat user's spinal column extends in the longitudinal direction of the backrest when the seat is used correctly; a lumbar support which is arranged on the front side of the backrest frame and is intended for supporting a seat user's back; and an adjustment device for setting the position of the lumbar support perpendicular with respect to the plane of extent of the backrest frame in order to adjust the curvature of a backrest cushion which is arranged in front of the backrest frame and the lumbar support and via which a vehicle occupant's back is supported on the lumbar support.

DE 203 13 925 U1 describes a lumbar adjustment device, in which a flat construction of the adjustment device of the lumbar support is produced by the fact that, in order to set the position of the lumbar support perpendicular with respect to the plane of extent of the backrest frame, use is made of a slide which moves essentially along the plane of extent of the backrest frame or slightly obliquely with respect thereto and interacts here via a ramp with an adjustment element, which is designed as a bow, such that the position thereof (together with the lumbar support itself) is adjusted transversely with respect to the direction of movement of the slide.

### SUMMARY

The invention is based on the object of improving a lumbar adjuster of the type mentioned at the beginning, in particular with regard to construction space and outlay on components.

According to the invention, it is provided that the at least one slide is arranged in the scissor region of the bows such that, for the adjustment of the one bow, the slide is supported on the other bow. Furthermore, various embodiments of the invention are explained with reference to the figures.

### DETAILED DESCRIPTION

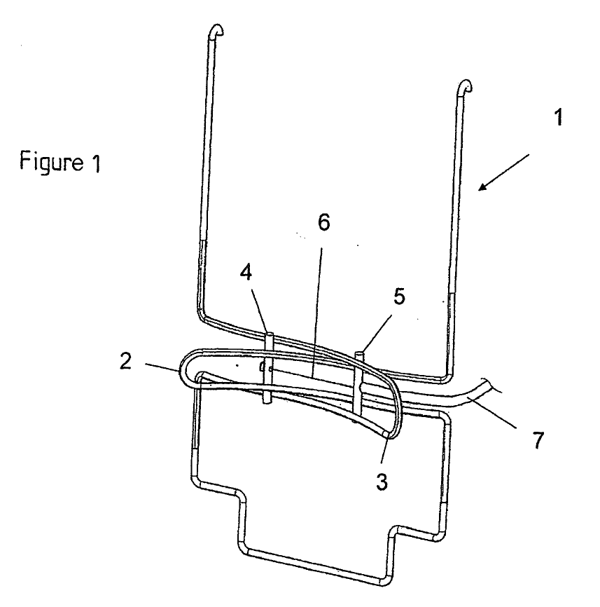

FIG. 1 shows the lumbar adjuster according to the invention in a perspective view. The frame 1 which supports the adjuster is manufactured from wire. Two intersecting bows 2, 3 are formed on two opposite regions, with one bow 2 engaging in the other bow 3, i.e. having a correspondingly smaller width. A respective side 4, 5 which is in the form of a cylindrical body is placed in the intersecting regions of the bows 2, 3, said slides being moved in relation to each other via a Bowden cable-pull system 6, 7. Each of the slides 4, 5 is supported on the respectively other bow 2, 3. The cable 6 is coupled directly to the one slide 4 and is guided through the other slide 5. The Bowden tube 7 is supported on said slide 5. The cable 6 is tensioned by an adjuster (not illustrated) using a motor or by hand. A spring element may be arranged between the slides 4, 5—said slides already being pushed apart from each other by the force of the upholstery (lumbar mat—not illustrated) acting on the bows 2, 3, and therefore a spring means may also be omitted.

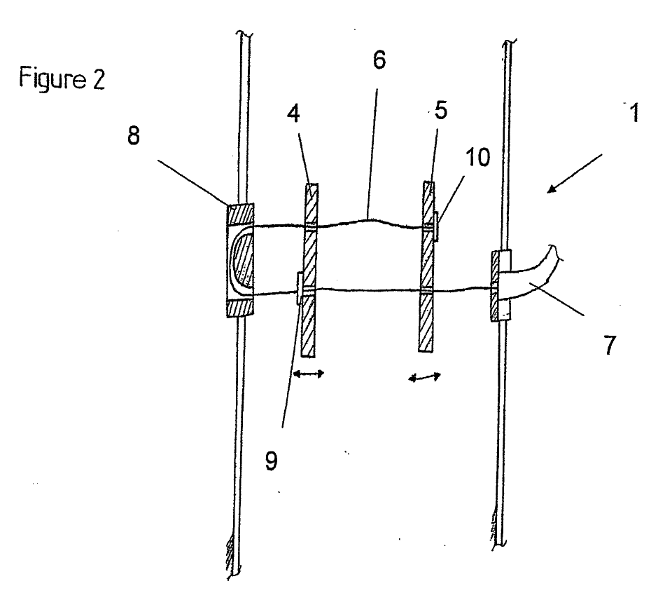

FIG. 2 shows a cable adjustment, with the Bowden tube 7 being supported on one side of the frame 1 and the cable 6 on the other side of the frame 1 having a deflection 8. Before and after the deflection 8, the cable 6 is guided through the two slides 4, 5 and carries along the respective slide 4, 5 via a respective nipple 9, 10.

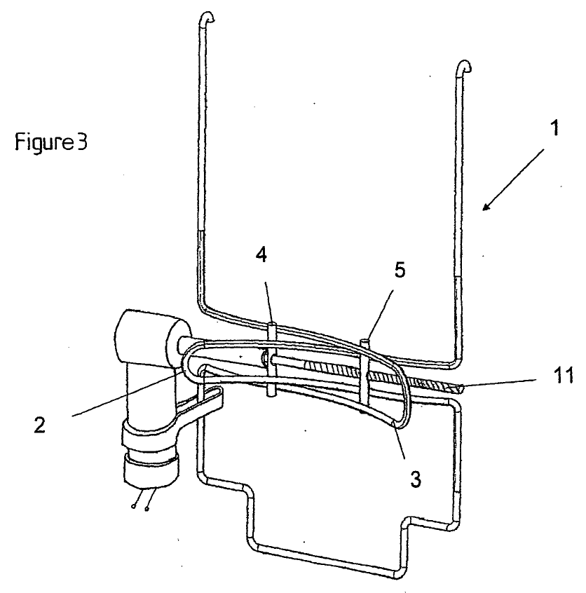

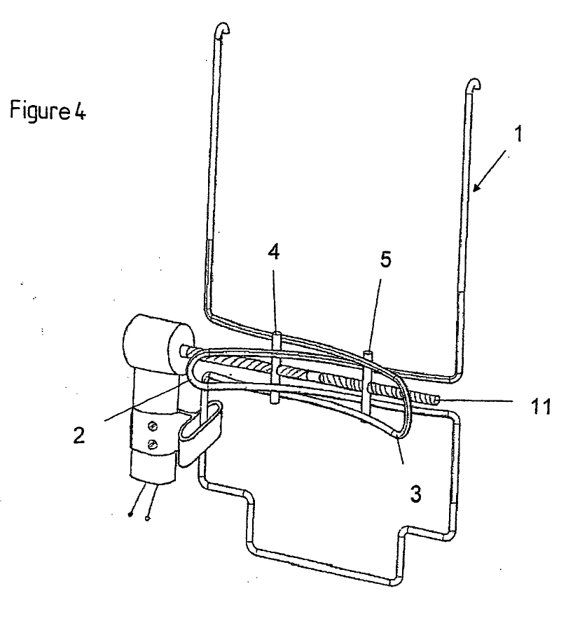

FIGS. 3 and 4 describe a motorized adjustment with a spindle 11 which is driven by a motor. One of the slides 4, 5 or both of them has or have a threaded nut. In the version according to FIG. 3, the spindle drive is supported on the one slide 4—the second slide 5 has the spindle nut. In FIG. 4, the spindle 11 has a left to right threaded section. The slides 4, 5 each have a spindle nut with a left-hand or right-hand thread. The motor for the spindle drive is supported on the frame 1 in an articulated manner.

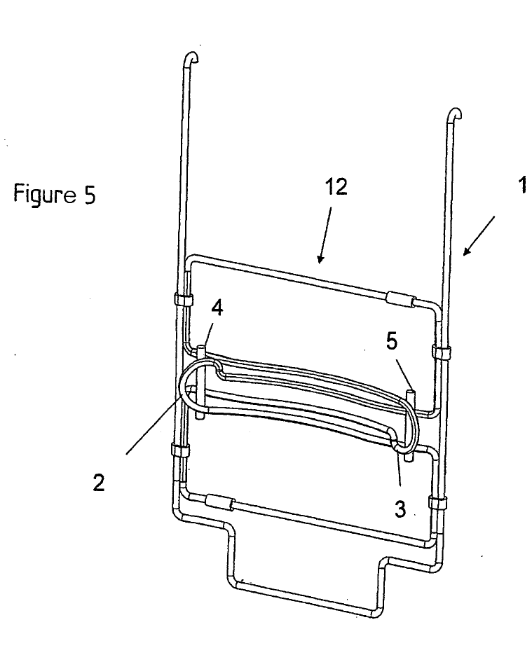

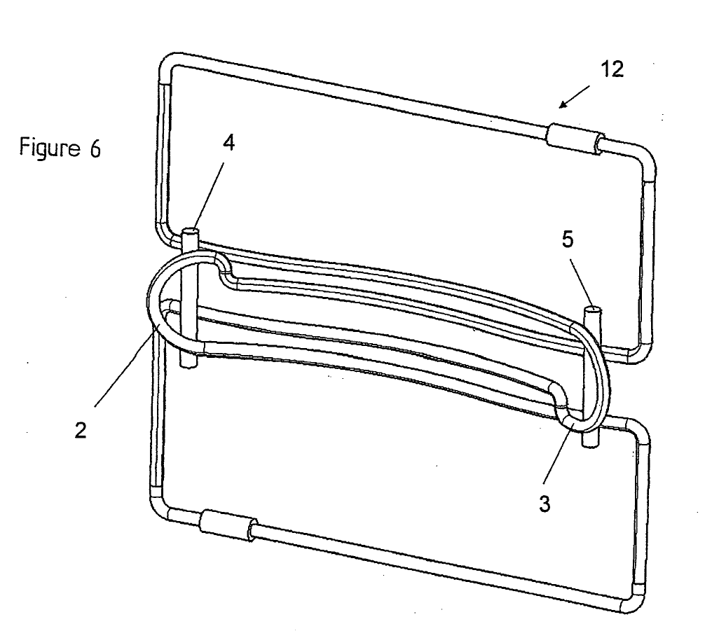

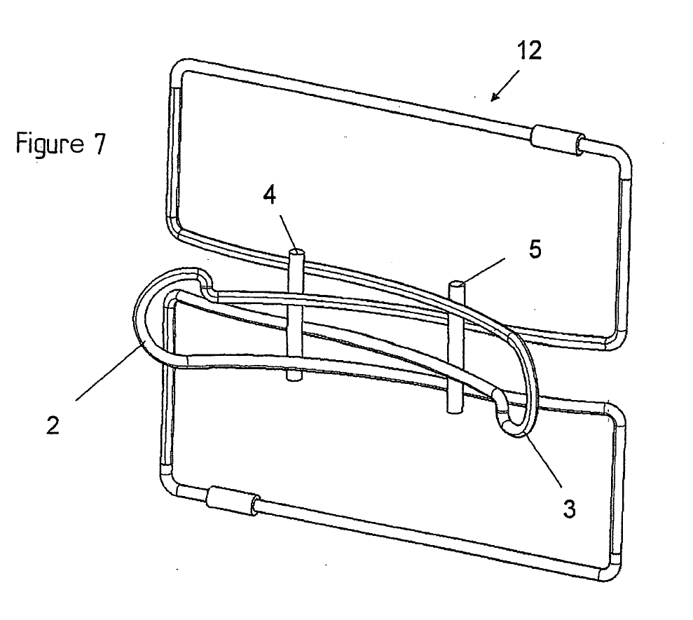

FIGS. 5-7 illustrate an embodiment, in which the bows 2, 3 are fitted to a frame 1 which is composed of two correspondingly shaped, symmetrical wire parts. This frame 12 is then fitted into a further frame 1 located in the backrest structure (not illustrated). FIGS. 6 and 7 show the bows 2, 3 in two different positions. In the embodiments illustrated here of the invention, the joints of the bows 2, 3 are designed as bending joints.

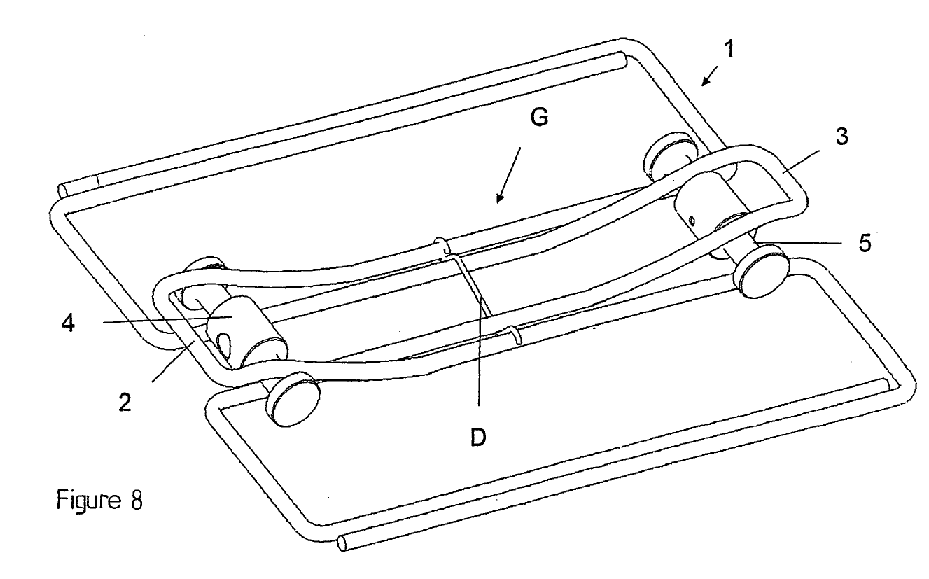

FIG. 8 shows an embodiment of the invention, in which the two bows 2, 3 are coupled to each other by a joint G. The joint is formed in this case by a wire connection D of the two bows 2, 3 in such a manner that the one limb of the bow 2 is supported on the adjacent limb of bow 3 via the wire connection. In comparison, the limb of bow 3 is supported on the limb 2 via the wire connection D. This results in centering of the slides 4, 5 which can be moved via a cable pull (not illustrated here). Both slides are thus always at the same distance from the pin of the joint G.

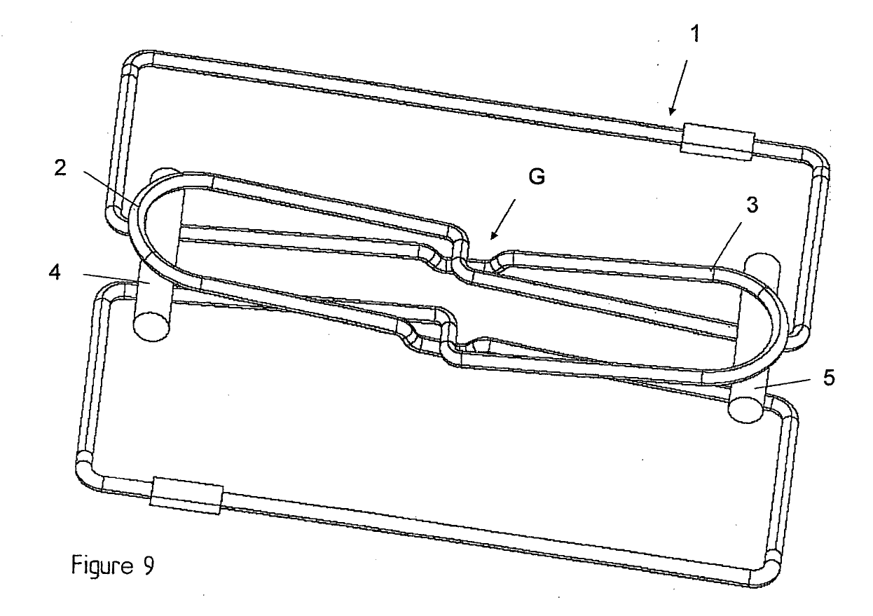

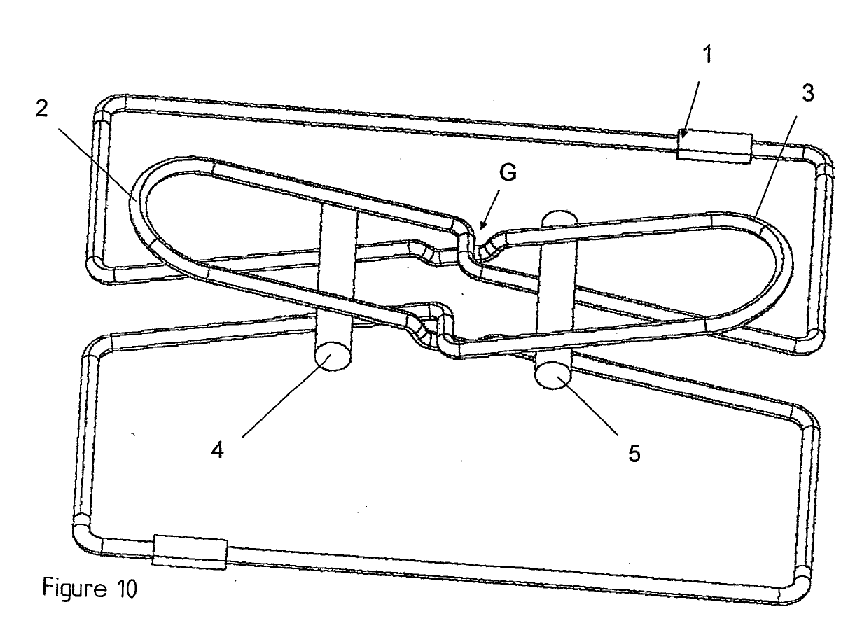

FIGS. 9 and 10 illustrate an embodiment of the invention, in which the limbs of the two bows 2, 3 are each formed in the central region in such a manner that they embrace perpendicularly. As in the previously described embodiment, the one limb of bow 2 is thus supported on that limb of bow 3 which reaches under it. On the other side, the region which runs perpendicularly with respect to the extent of the bow 3 is supported on the limb of bow 2. The joint G formed in this manner operates according to the principle of a rolling cradle-type joint. FIG. 9 shows the flat setting of the lumbar adjuster with slides 4, 5 far away from each other—in FIG. 10, the bows are greatly interlaced.

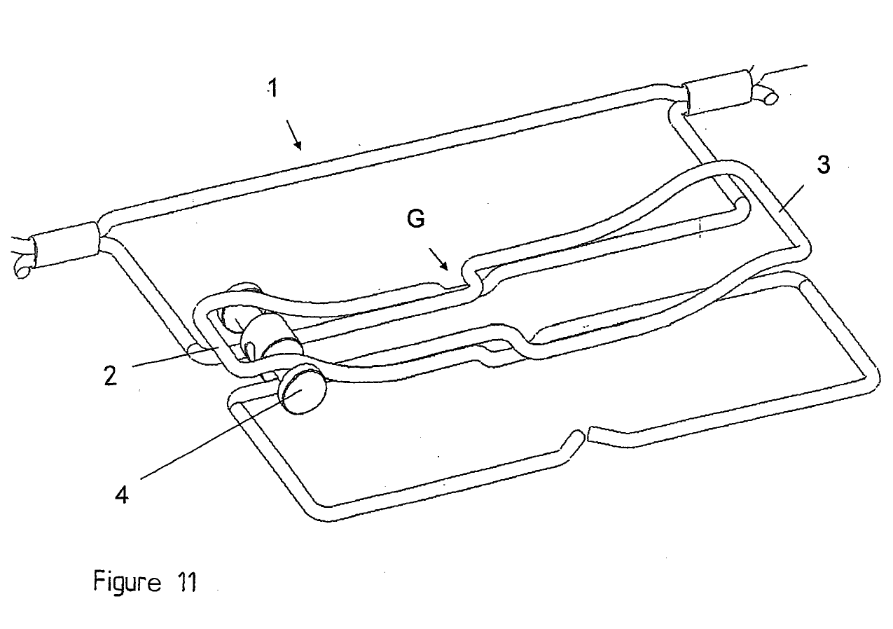

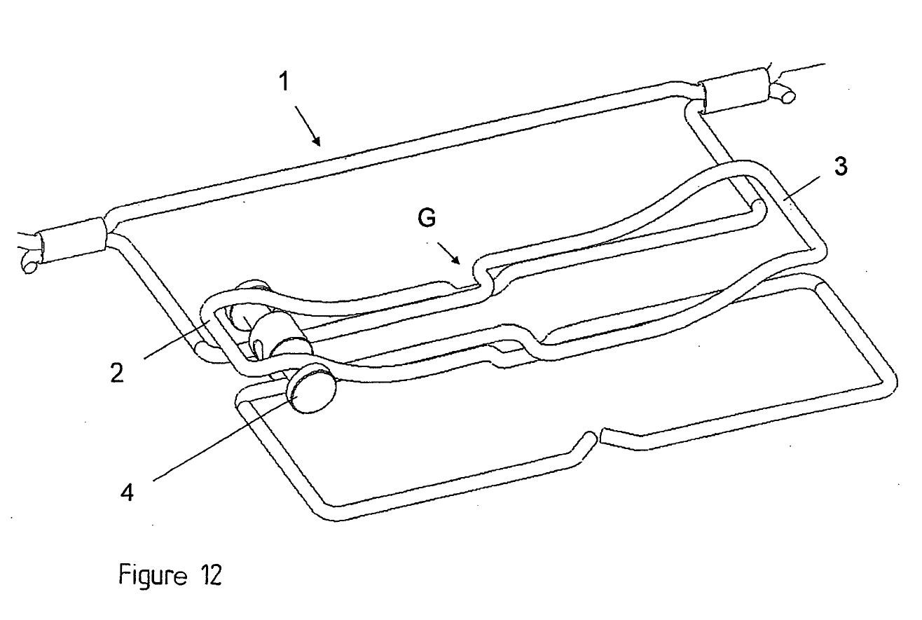

In the embodiment of the invention according to FIGS. 11 and 12, only one slide 4 is provided for pivoting the two bows 2, 3. Similar to the manner described previously, the bows 2, 3 are coupled to each other in a manner such that they are mutually supported on each other in the manner of a rolling cradle-type joint G. The one slide 4 can be moved in the direction of the joint via a cable (not illustrated), with the two bows 2, 3 pivoting as a consequence of this movement and the coupling via the joint G. In FIG. 12, the slide 4 is pulled in the direction of the joint G. The Bowden tube which surrounds the cable is supported here on the frame 1 of the lumbar adjuster. As an alternative to this, the slide 4 may also be moved via a drivable spindle. The drive of the spindle is then likewise supported on the frame 1 of the lumbar adjuster. The actuation of the cable (not illustrated) or of the spindle (not illustrated) can take place manually or by motor.

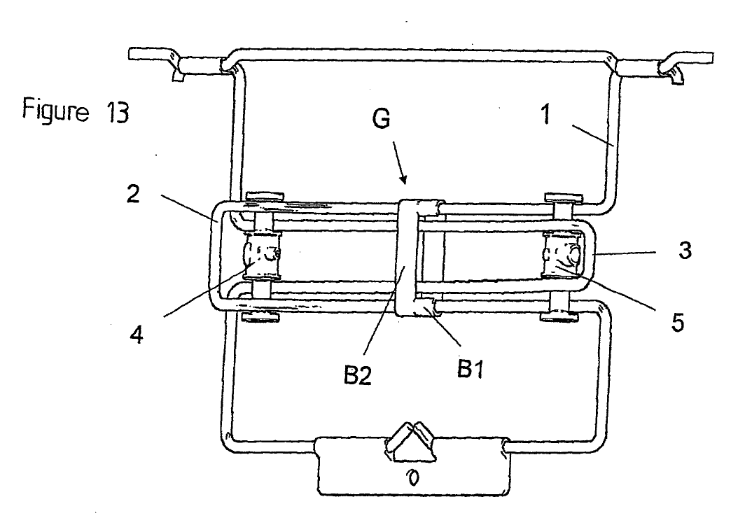

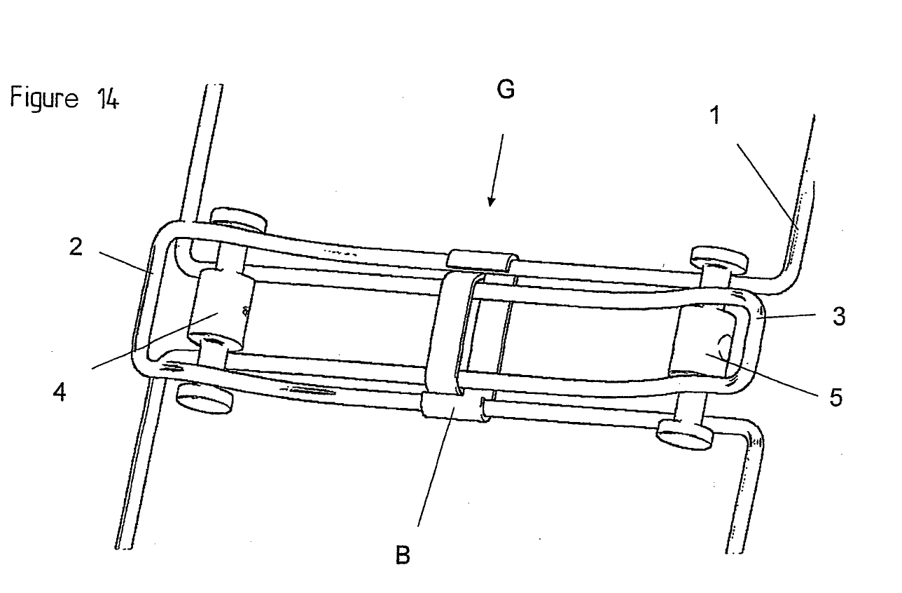

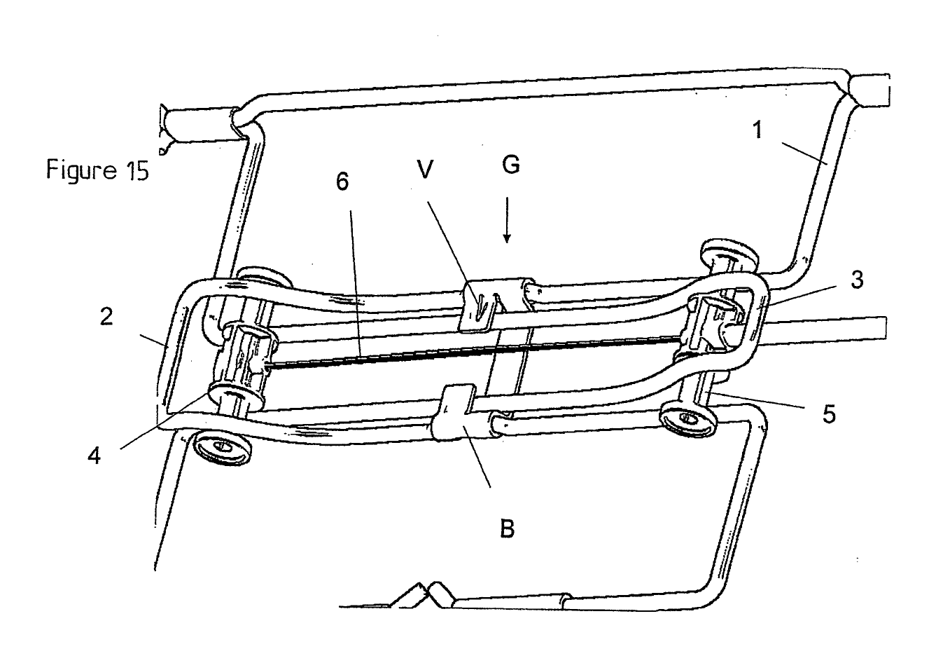

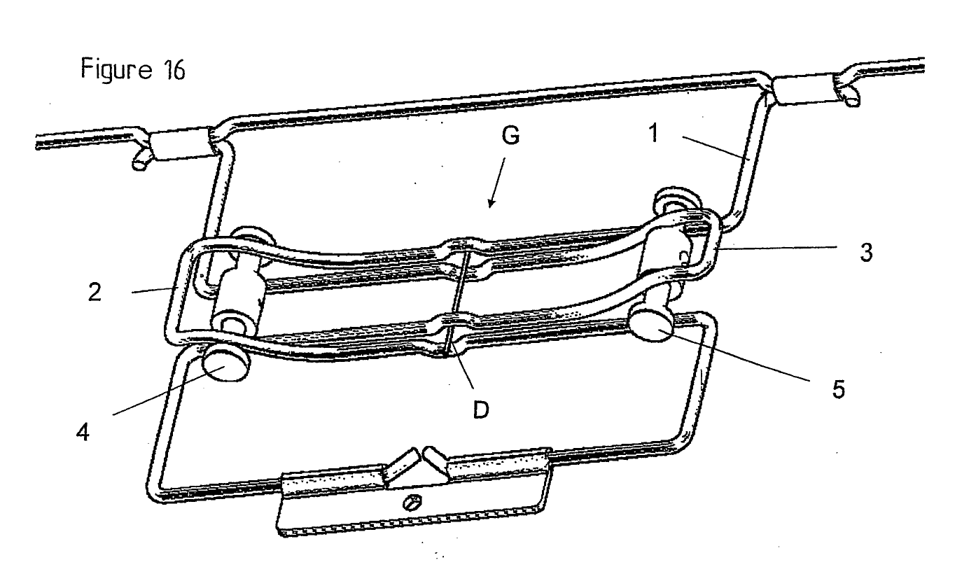

The versions according to FIGS. 13-16 show further refinements of the joint G. According thereto, two sheet-metal parts B1, B2 (FIG. 13) or a sheet-metal part B (FIG. 14) having two tabs is/are provided. FIG. 15 shows a sheet-metal part with a lower continuous tab and two upper webs, the latter each having a stiffening rib V for stiffening purposes. In the case of FIG. 16, a wire pin D is provided as the joint G.

1-21. (canceled)

22. A lumbar adjuster for a motor vehicle seat, the lumbar adjuster comprising:
a frame; and
two pivotable bows on the frame intersecting in a manner of a pair of scissors;
a linearly movable slide coupled to at least one of the bows to pivot the at least one bow;
wherein the slide is arranged in a scissor region of the bows.

23. The lumbar adjuster of claim 22, wherein the two bows are coupled by a joint.

24. The lumbar adjuster of claim 22, wherein the slide coupled to the at least one of the bows is supported on the other bow.

25. The lumbar adjuster of claim 22, further comprising another slide coupled to the other bow to pivot the other bow.

26. The lumbar adjuster of claim 22, wherein the slide is movable via a manual drive.

27. The lumbar adjuster of claim 22, wherein the slide is movable via a motor drive.

28. The lumbar adjuster of claim 26, wherein the slide is movable via a drivable spindle.

29. The lumbar adjuster of claim 26, wherein the slide is movable via a cable pull.

30. The lumbar adjuster of claim 25, wherein one of the slides is movable via a cable coupled to the slide, and the other slide is movable via a Bowden tube which accommodates the cable.

31. The lumbar adjuster of claim 30, wherein the cable is guided between two frame parts and has a catch for each of the slides.

32. The lumbar adjuster of claim 24, wherein the one slide is movable via a cable coupled to the slide, and wherein a Bowden tube accommodating the cable is supported on the frame.

33. The lumbar adjuster of claim 22, wherein the bows are configured as shaped regions of the frame forming lumbar adjustment.

34. The lumbar adjuster of claim 28, wherein the frame comprises two parts, wherein each frame part has one of the bows.

35. The lumbar adjuster of claim 28, wherein the frame is manufactured from wire.

36. The lumbar adjuster of claim 22, wherein the slide is configured as a cylindrical element.

37. The lumbar adjuster of claim 23, wherein the joint is formed by a pin which couples the bows.

38. The lumbar adjuster of claim 37, wherein the pin reaches through the two bows.

39. The lumbar adjuster of claim 23, wherein the joint is configured as a wire element which connects the two bows.

40. The lumbar adjuster of claim 23, wherein the joint is formed by the two bows being mutually supported on each other.

41. The lumbar adjuster of claim 23, wherein the joint is configured in the manner of a rolling cradle-type joint.

42. The lumbar adjuster of claim 23, wherein the joint is formed by specially shaped and embracing regions of the bows.
